(19) United States
(12) Patent Application Publication
(10) Pub. No.: US 2004/0080148 A1
(43) Pub. Date: Apr. 29, 2004

(54) Vertigo Protection Bar Cage

(76) Inventor: Rosemary G. Brennan, Mansfield, PA (US)

Correspondence Address: ROSEMARY G. BRENNAN, 29 NORTH HILL TERRACE, MANSFIELD, PA, 16933, US

(21) Appl. No.: 10/402,770

(22) Filed: Mar. 29, 2003

Related U.S. Application Data
(60) Provisional application No. 60/369,153, filed on Apr. 2, 2002.

(51) Int. Cl. B60R 21/13

(52) U.S. Cl. 280/756

(57) ABSTRACT

This protection device for lawn mowers, lawn tractors, and “all terrain vehicles” (ATVs) consists of (3) one inch heavy duty metal tubeing bars that are bent and curved to provide a means of protection from falling from either side or the back of the machine. An optional horizontal bar could be secured to the back bar for added support. Heavy duty screws and clamps (or L braces) are used to secure the bars to the fenders or main part of the machine. This device is not intended to be used as roll bars are used, but can be used as grab bars to be firmly grasped in case of dizziness or accidental balance problems. The “Vertigo Protection Bar Cage” kit is offered in two sizes—large for lawn tractors and medium for lawn mowers and ATVs.

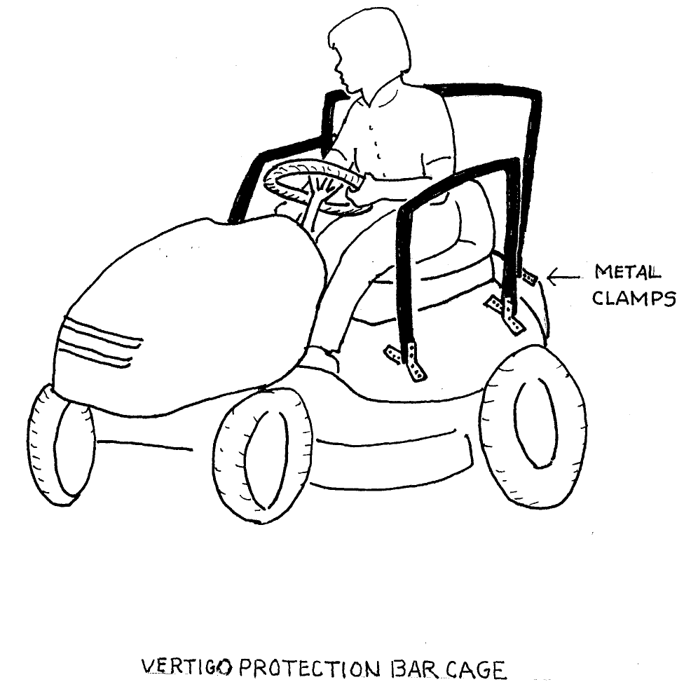

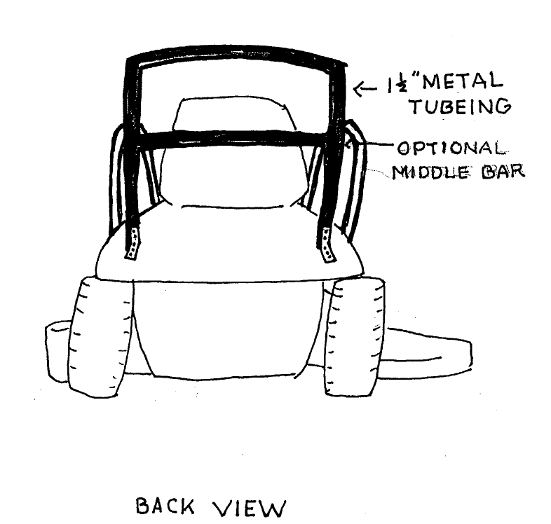

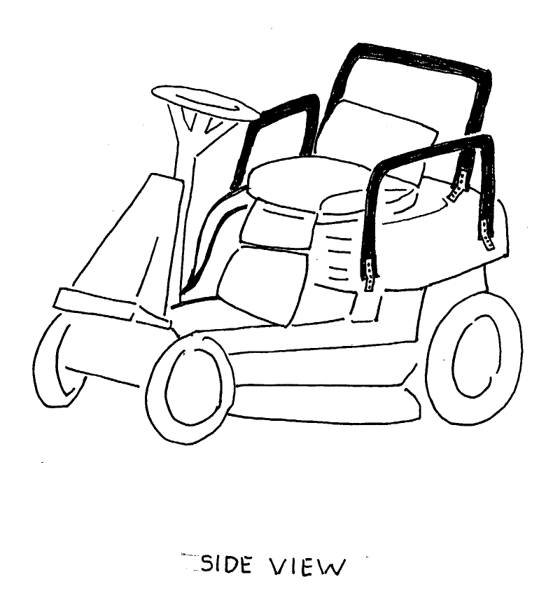

### BACKGROUND OF THE INVENTION

Two years ago my husband had medical tests which verified that he had Vertigo, which is an affliction that means the same as dizziness attacks. I soon became aware of how common this condition has become. I saw an immediate need for this VPB Cage device for lawn tractors and mowers for those who experience occasional and unexpected vertigo but still wish to operate their lawn machines.

In the last years the popularity of the many different types of youth sized recreational vehicles such as ATV's suggests yet another possible use for the VPB cage as a safety device.

### SPECIFICATIONS

A Vertigo Protection Bar Cage (VBS Cage) consists of three heavy-duty metal arched bars that are securely fastened with clamps and screws to the lawn tractor, mower or recreational vehicle. The side bars are approximately 1½ feet high while the back bar measures 2½ feet high. The three bar arches form a cage around the driver seat that acts as a protection in helping to prevent the driver from falling from the machine should he experience the sudden stiffening and loss of equilibrium that occurs with a vertigo attack, or in the case of an RV accident.

1. What I claim for my invention, the Vertigo Protection Bar Cage, is that it offers a means of protection by helping to prevent the drivers of lawn machines or youth recreational vehicles from falling from their machines in case of a sudden dizzy spell or ATV accident. However, the driver of a lawn machine must be responsible for removing his foot from the gas pedal and tightly gripping the bars until he is helped from the machine. I make no claim in either use for the actual prevention of accidents or injuries.
